(19) United States
(12) Patent Application Publication
(10) Pub. No.: US 2007/0181090 A1
(43) Pub. Date: Aug. 9, 2007

(54) Pan with a flexible liner

(76) Inventor: Olivier Jeanne, St. Junien (FR)

Correspondence Address: HARNESS, DICKEY & PIERCE, P.L.C., P.O. BOX 828, BLOOMFIELD HILLS, MI, 48303, US

(21) Appl. No.: 10/850,035

(22) Filed: May 20, 2004

(30) Foreign Application Priority Data
Jun. 3, 2003 (FR) 03 06669

(51) Int. Cl. F02B 77/00; F02F 7/00

(52) U.S. Cl. 123/195 C

(57) ABSTRACT

A pan, particularly for an internal combustion engine, comprising an enclosure intended to be connected to the engine. The pan contains an internal, flexible liner that preferably has a profile corresponding to that of the enclosure.

### CROSS-REFERENCE TO RELATED APPLICATIONS

This application claims the benefit of French Patent Application 03 06669, filed Jun. 3, 2003. The disclosure of the above application is incorporated herein by reference.

### FIELD OF THE INVENTION

The present invention relates to a pan with a flexible liner that forms a cover or a housing. The pan may be used, in particular, as an oil pan or cylinder head cover for internal combustion engines.

### BACKGROUND OF THE INVENTION

In internal combustion engines of motor vehicles, particularly those of cars and trucks, there is provided an oil circuit that permits the lubrication of the engine. A pump connected to the engine system ensures the pressurization and circulation of the oil. This pump draws directly from an oil pan that acts as a tank.

This pan is necessarily placed at a low point to be able to recover the oil by gravity and, hence, is located beneath the engine block. In most cases, the pan is not an integral part of the engine block, but is connected to it from below.

It will be immediately understood that the pan is vulnerable to road obstacles and that it is located at a ground tolerance limit because the engine is generally positioned as low as possible for obvious reasons related to lowering the center of gravity. Hence, the strength of the pan must be adapted to endure statistically probable shocks.

Further, the oil circulates at a temperature of about one hundred degrees centigrade. As such, the pan containing the oil must not only be able to resist such temperatures, but it must undergo only the most limited deformations possible, particularly when hot, which implies a certain mechanical resistance.

Moreover, taking into consideration that engine performance is constantly increasing, lubrication plays a more and more important role so that, even in low-capacity engines, the volume of circulating oil is necessarily large and, hence, the pan volume is also large. The two are proportional, so that for truck engines the pan volumes are clearly very large.

A special feature of these oil pans is the presence of a draining plug at the bottom of the pan. The draining plug is used to drain the pan completely for an oil change, even though the tendency is to do the draining less frequently thanks to the improvement in oil quality and progress in the design of the engines themselves.

It is necessary to note at this stage of the presentation of the prior art that for engines and for motor vehicles in general, weight reduction is constantly preoccupies designers. For this reason, current pans are made either of sheet metal shaped by stamping, of cast aluminum, or of a composite material. A flange is provided at the periphery of the pan to enable it to be fastened to the engine block. A gasket is interposed between the two to ensure tightness. This flange protrudes toward the outside to permit the use of screws to ensure the connection.

This arrangement leads to the installation of pans that present another major drawback, namely that of generating or at least amplifying noise, particularly noise coming from the engine block, by the pan acting as a sounding board. In fact, to ensure adequate tightness, even on temperature, and to provide perfect connection to the engine block, the fastening points are numerous and regularly distributed along the peripheral flange.

By this pronounced tightening, the gasket, even if it is made of an elastomer, presents a certain rigidity which prevents the elimination of certain noise, particularly that of a low frequency which is the most disturbing noise. As such, the damping intended to be provided by the elastomer barrier disappears.

To limit this noise, it is advantageous to provide sound decoupling of the pan from the engine block while ensuring adequate fastening.

It is known from European patent application EP 1,239,125 that the desired decoupling can be obtained by providing a first metallic flange firmly attached to the engine block by means of screws, a second metallic flange fabricated in one piece with the pan and also fastened to the engine block by the same spacing screws with elastic washers to break the vibration bridges, and an elastomeric gasket interposed between the first and the second flange and ensuring tightness. The gasket is directly connected to the two flanges by molding, but this step remains industrially difficult.

Moreover, the main drawback of this approach is that it works only for high frequencies, because the gasket must ensure a compromise between tightness requiring high rigidity and decoupling requiring low rigidity. As a result, other approaches have been investigated, which led to the subject matter of the present invention.

Applicant has also made an interesting observation concerning cylinder head covers for internal combustion engines. In fact, this industrial part is subject to exactly the same constraints as are oil pans. This part has a complicated shape and it must, in particular, have sufficient mechanical strength to allow the connection of parts such as an oil separator on the outside and/or hoses or fastening lugs on the outside. Tightness must be ensured, the fluid is the same, because the same engine oil is involved, and the temperatures are also identical.

Similarly, whereas the draining plug is certainly no longer required, the oil filling plug is situated on the cylinder head cover and imposes approximately the same constraints as the draining plug.

The sound nuisances generated by the mechanical parts operating in a closed space and/or emitted by the cylinder head and the engine block are amplified thus contributing to the discomfort of the passengers in vehicles using such engines.

### SUMMARY OF THE INVENTION

The solution to the problem provided by the present invention is applicable to oil pans as well as to cylinder head covers of internal combustion engines.

To this end, the pan according to the invention, particularly for a internal combustion engine, comprises an enclosure intended to be directly or indirectly connected to the engine. The pan comprises an internal flexible liner that preferably has a profile that corresponds to that of the enclosure. The enclosure comprises a tank and at least one peripheral flange fitted with means of fixation to the engine, as well as means of fixation to the internal, flexible liner.

The means of fixation of the flange to the engine comprise threads on the side of the engine. On the side of the enclosure they comprise holes, screws and washers, at least one of which is acoustically insulating. The screws are screwed into the threads and absorb only mechanical stresses.

As for the means of fixation of the internal, flexible liner, at least one recess is provided in the flange, on the inside, that is intended to receive a thick profile provided on a free edge of the liner that has a cross-section corresponding to that of the recess.

According to one improvement, the liner comprises peripheral bellows.

According to one embodiment, the flange is a double flange with two parts offset from the tank beyond the space taken up by the engine. Fastening screws connect the double flange to the engine, and another set of fastening screws connect the two parts of the double flange.

In addition, the pan comprises a cover with a threaded hole provided with a shoulder, an annular rim integral with the liner, and a plug that allows the threaded hole to be closed.

According to another variant, the pan comprises a tranquilizer disposed within the space defined by the liner.

Advantageously, the liner comprises walls that are approximately parallel to those of the enclosure, with edges inclined toward the outside.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded view in perspective of an engine oil pan according to a principle of the present invention;

FIG. 2A is a cross-sectional view of the pan before installation;

FIG. 2B is a cross-sectional view of the pan after installation;

FIG. 3 shows a variant of the pan according to a principle of the present invention with volume extension; and

FIG. 4 is a detailed view of an opening.

### DETAILED DESCRIPTION OF THE PREFERRED EMBODIMENTS

The following description of the preferred embodiment(s) is merely exemplary in nature and is in no way intended to limit the invention, its application, or uses.

Moreover, the following description and the associated drawings concern an oil pan for an internal combustion engine, but could find direct application in designing a cylinder head cover, as only the shapes and connections would be different in terms of their geometries and locations.

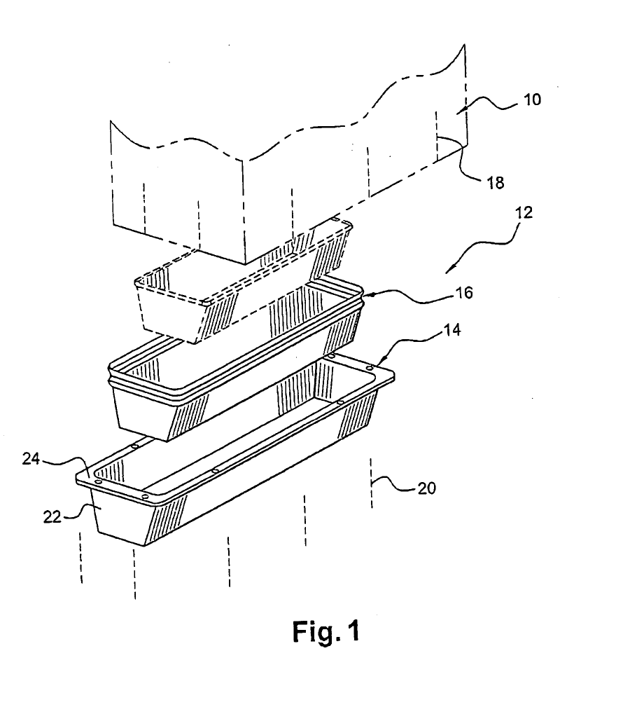

In FIG. 1, the engine block is indicated by reference numeral 10 whereas the pan of the invention 12 comprises at least two elements, an enclosure 14 and an internal, flexible liner 16 with a profile corresponding to that of the enclosure.

The engine block of the known type contains threads 18 for receiving screws 20.

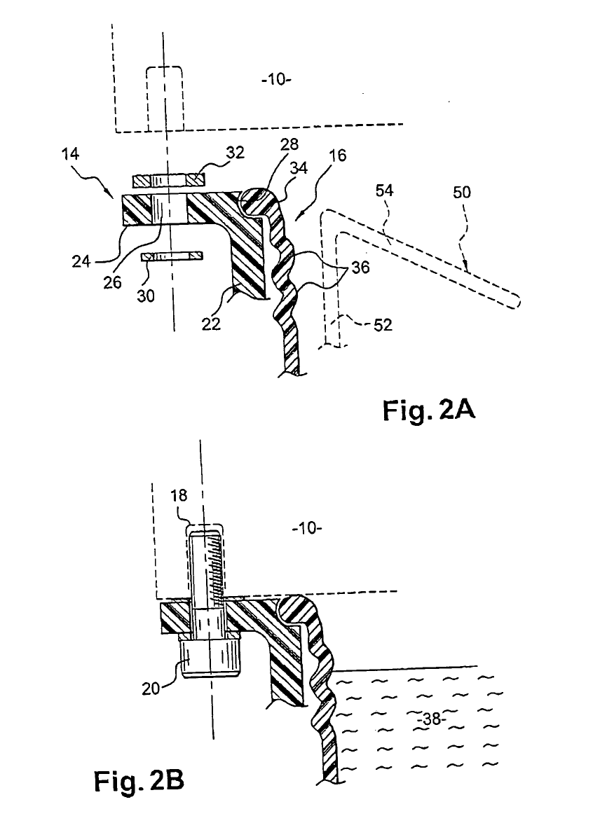

Enclosure 14 has sufficient mechanical strength to mechanically support the contents of the pan 12, namely the oil. Preferably, the mechanical strength also enables it to withstand defined shocks, particularly those caused by stones thrown at a given speed. Within the framework of the invention, a plastic material is sufficient, and recourse to metals is not needed. Also, recourse to composites is not required because, as will be described hereinbelow, the enclosure is not in direct contact with the contents of the pan. The enclosure 14 has an unusual structure that can be seen in FIGS. 2A and 2B.

As shown in FIGS. 2A and 2B, there is provided a tank 22 surmounted by a peripheral flange 24 which in this case, according to a first variant, is molded to the tank 22. The flange 24 protrudes toward the outside of the tank 22. In this flange 24 are provided holes 26 for the passage of screws 20. On the inside of the flange 24 is provided a recess 28 capable of receiving a liner 16, as will be explained further below.

In addition, a rigid washer 30 and a washer 32 made of a compressible elastomer. are disposed on two sides of the flange 24 to ensure adequate mechanical mounting with effective tightening and acoustic insulation.

The liner 16 is made of at least one elastomeric material that is resistant to hydrocarbons and to the temperature to which the oil is subjected. It is preferable that this elastomer also have excellent aging resistance.

Preferably, the liner 16 is configured so as to conform to the shape of the tank 22 and the enclosure 14. Its free edge has a thick profile 34 corresponding to that of the recess 28 so as to be able to be forced into the recess 28 and remain blocked in it. Note that, before mounting and tightening, this thick profile 34 extends beyond the top, as shown in FIG. 2A.

The liner 16 can be provided with peripheral bellows 36 that facilitate the installation and the placement in the enclosure 14, while permitting conformation to the volume of the tank 22 receiving the liner 16 without, as a result, creating deformations of the elastomer itself.

FIG. 2B shows the deployment of these bellows 36 when a fluid 38, in this case oil, is introduced into the pan 12. When the screws 20 are tightened, one can also observe compression of the thick edge of the liner 16 against the engine block 10. This compression ensures a tight seal at the interface between the liner 16 and the engine block 10. The tightening does not have to be very thorough because as result of the elastomer surface being small, the pressure against this sealing barrier is high.

The elastomer along this barrier is flanged and its rigidity is high, but there is no sound transmission, or the sound is at least strongly attenuated, because the walls of the liner 16 damp the vibrations generated within the free volume it contains, regardless of the frequency and including the low frequencies.

A dissociation of functions also exists. That is, the enclosure 14 absorbs the mechanical stresses, and the liner 16 ensures tightness of the system. From the standpoint of industrial production, the two pieces are easy to fabricate and, in particular, can be quickly pre-assembled.

Another advantage is that the number of tightening points, and thus the number of screws 20, is reduced. The number of blind holes on the engine block 10 is thus also reduced, resulting in substantial savings.

Such a pan 12 makes it possible to preserve tightness even if the enclosure 14 of the pan 12 has deteriorated as a result of shock. In fact, in the case of a reasonable shock to the enclosure 14 such that the enclosure 14 cracks, the flexible liner 16 remains unaffected so that there is no interruption in the operation of the engine equipped with a pan 12 according to the invention. Also, the material of construction may be chosen from among less noble ones, resulting in reduced cost. This is because the required technical characteristics are reduced, particularly the aging resistance, heat resistance and resistance to contact with hydrocarbons, in view of the fact that these constraints are transferred to the liner 16.

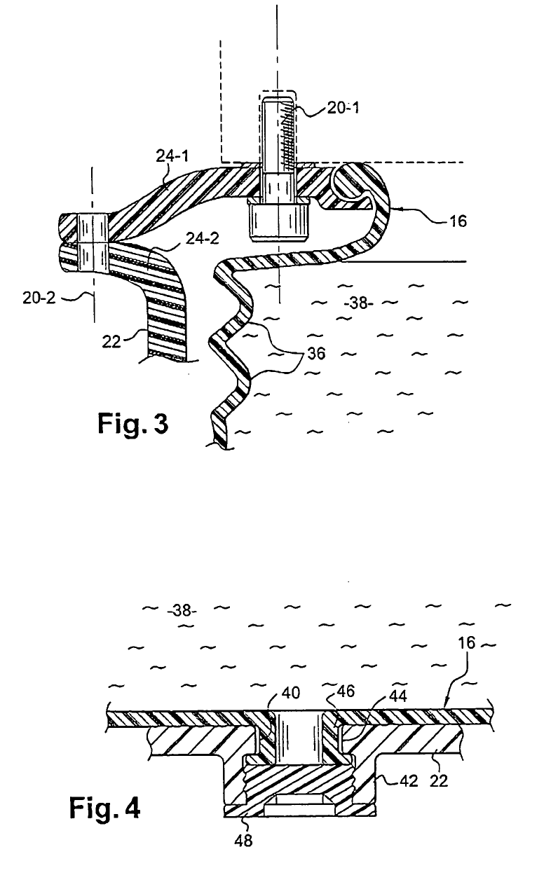

The variant of the invention represented in FIG. 3 provides additional advantages. In fact, flange 24 is actually doubled and comprises two parts, 24-1 and 24-2.

Depending on the shape given to each of these parts, it is thus possible to ensure that even if the tank 22 is offset beyond the space taken up by the engine block 10, access to screws 20-1 for fastening to the engine block 10 and to screws 20-2 for linking the two parts will still be possible. In fact, after removing screws 20-2, it is possible to access screws 20-1 by displacing the liner 16 even if it contains a fluid.

Since screws 20-2 are intended to ensure mechanical integrity, the number of screws 20 is reduced, because no tightness function needs to be provided. For example, tank 22 is fixed by means of washer-type flexible fasteners and/or by interposing elastomeric washers between tank 22 and part 24-1 of the flange.

Firstly, this offset leads to an increase in the available volume of fluid 38 without increasing the depth which would result in a reduced ground clearance. Another advantage is that the enclosure can be replaced very rapidly, because it suffices to remove screws 20-2 to install a new enclosure without removing screws 20-1 and thus without affecting the tightness. Thus, it is not necessary to drain the fluid for this purpose, either.

According to another characteristic of this variant, flange 24-1 and the liner 16 can form a single piece obtained, for example, by making an elastomeric link adhere to the flange. Moreover, the variant of FIG. 3 shows that tank 22 is not connected directly to the engine block 10, as is the case in the variant of FIG. 2A, but is connected to it indirectly.

In this case, decoupling is optimized, because the tank 22 is simply suspended from the flange 24 which in turn is connected to the engine block 10, wherein the liner 16 ensuring tightness.

To remove the fluid, it is necessary to provide an opening 40 although it is possible to provide means for removing the fluid 38 by aspiration. This opening 40, shown in FIG. 4, comprises a threaded hole, preferably obtained by molding to the bottom of tank 22. The threaded hole is provided with a shoulder 44 on which rests an annular rim 46 molded to the liner 16.

A plug 48 makes it possible to close the threaded hole.

It was found that such an arrangement allows one to make do without the presence of an independent gasket, because the rim 46, which preferably consists of an elastomer that is provided between the shoulder 44 and the plug 48, contributes to tightness.

According to an improvement of the invention, it is possible to provide a tranquilizer 50 within the volume defined by the liner 16. Such a tranquilizer 50 consists of a wall 52 approximately parallel to the walls of the enclosure 14 with edges 54 inclined toward the interior, as shown by broken lines in FIGS. 1 and 2A. This tranquilizer 50 is advantageously fastened to the enclosure 14 through the liner 16, preferably at the bottom, opposite opening 40.

Such a tranquilizer 50 prevents excessive movement of the fluid 38 during acceleration, braking or turning of the vehicle.

According to another characteristic of the invention, an external surface of the liner 16 can contain protruding elements such as, for example, grooves. The protruding elements provide an air space between the liner 16 and the tank 22 thus contributing to improvement of sound and heat insulation.

Moreover, according to the invention it is possible to provide between the tank 22 and the liner 16 sensors for temperature, oil level or other parameters, wherein these different elements and their connections being protected by tank 22.

The description of the invention is merely exemplary in nature and, thus, variations that do not depart from the gist of the invention are intended to be within the scope of the invention. Such variations are not to be regarded as a departure from the spirit and scope of the invention.

1. A pan for an internal combustion engine, comprising:
an enclosure intended to be connected to the engine; and
an internal, flexible liner having a profile corresponding to that of said enclosure.

2. The pan according to claim 1, wherein said enclosure includes a tank and at least one peripheral flange provided with means for fastening the enclosure to the engine as well as means for fastening the internal, flexible liner to the enclosure.

3. The pan according to claim 2, wherein the means for fastening said peripheral flange to the engine comprise threads on an engine side of said peripheral flange and holes, screws, and washers on an enclosure side of said peripheral flange, at least one of said washers being acoustically insulating, and said screws being screwed into said threads and absorbing mechanical stresses.

4. The pan according to claim 2, wherein the means for fastening the internal, flexible liner to said enclosure comprise, on an inside of said enclosure, at least one recess provided in said peripheral flange and intended for receiving a thick profile on a free edge of said liner and having a cross-section corresponding to that of said recess.

5. The pan according to claim 1, wherein the liner includes a plurality of peripheral bellows.

6. The pan according to claim 2, wherein the flange includes a first flange and a second flange that are offset from the tank from a space taken up by the engine; and screws fasten said first flange and said second flange to the engine, and additional screws connect the first flange and second flange together.

7. The pan according to claim 1, further comprising an opening with a threaded hole provided with a shoulder, an annular rim fabricated to be part of the liner, and a plug for closing said threaded hole.

8. The pan according to claim 1, further comprising a tranquilizer disposed within a volume defined by said liner.

9. The pan according to claim 8, wherein said tranquilizer comprises walls are approximately parallel to walls of the enclosure, with edges inclined toward the interior.

10. An oil pan for an engine, comprising:
a tank including a flange, said flange for mounting said tank to the engine and including a recess; and
a flexible liner including a shape that corresponds to a shape of said tank, said flexible liner being disposed in said tank and connected to said flange by a free edge that is disposed in said recess of said flange.

11. The oil pan according to claim 10, wherein said flexible liner comprises a heat resistant material.

12. The oil pan according to claim 10, wherein said flange includes a first flange and a second flange, said first and second flange being connected to each other at a position that is offset from the engine.

13. The oil pan according to claim 12, wherein said first flange includes a first connection portion and a second connection portion, said first connection portion connecting said flange to the engine, and said second connection portion connecting said first flange and said second flange.

14. The oil pan according to claim 10, wherein said free edge of said flexible liner that is disposed in said recess of said flange comprises a bulbous portion, said bulbous portion being compressed when. said flange is connected to the engine to provide a seal at an interface between said flange and said engine.

15. The oil pan according to claim 10, wherein an acoustically insulating washer is disposed between said flange and the engine when said tank is mounted to said engine.
